(19) United States
(12) Patent Application Publication
(10) Pub. No.: US 2011/0251976 A1
(43) Pub. Date: Oct. 13, 2011

(54) COMPUTING CASCADED AGGREGATES IN A DATA STREAM

(75) Inventors: Jayram S. Thathachar, Morgan Hill, CA (US); David P. Woodruff, Mountain View, CA (US)

(73) Assignee: International Business Machines Corporation, Armonk, NY (US)

(21) Appl. No.: 12/759,070

(22) Filed: Apr. 13, 2010

(51) Int. Cl. G06Q 40/00; G06F 17/18

(52) U.S. Cl. 705/36 R; 706/54; 705/38; 702/179

(57) ABSTRACT

A method for efficiently approximating cascaded aggregates in a data stream in a single pass over a dataset, with entries presented to the methodology in an arbitrary order includes receiving out-of-order data entries in the data stream, aggregating particular data entries into aggregated data sets from the data stream based on a first characteristic of the data entries, computing a normalized Euclidean norm around mean values of each of the aggregated data sets, calculating an average of all of the normalized Euclidean norms of each of the aggregated data sets, and calculating a value based on the first characteristic as a result of calculating the average of all of the normalized Euclidean norms.

### BACKGROUND

1. Field of the Invention

The present invention generally relates to estimating cascaded aggregates over a matrix presented as a sequence of updates in a data stream. The problem of efficiently computing a cascaded aggregate for various applications with this method presents itself in several applications involving time-series data. For example, the analysis of credit card fraud may consist of first identifying high-valued transactions for each customer, and then computing the average of all the customers. Other examples include stock transactions, where aggregates are determined over all customers for each company, and then aggregates are determined over all of the companies. In network traffic analysis, aggregates are determined over all destination addresses for each source address, and then aggregates are determined over individual source addresses.

2. Description of the Related Art

Formally, the data stream consists of arbitrary additive updates to elements (i, j), (see FIG. 1), for different values of i and j. For elements (i, j) that have at least one update “a” in the data stream, as shown in FIG. 2, where a_{ij} denotes the net value of the element (i,j) as determined by the updates. In these matrix-like structures, some cell entries have values a_{ij}, (corresponding to row i and column j), and other cell entries have null values.

A cascaded aggregate P∘Q is defined by evaluating aggregate Q repeatedly over each row of the matrix, and then evaluating aggregate P over the resulting vector of values. This problem was introduced by Cormode and Muthukrishnan. FIG. 3 illustrates the cascaded aggregate P∘Q, where P and Q are aggregate operators, being defined by computing one aggregate Q over each of the non-empty rows of the matrix, and then computing P over the vector of values of Q.

Previously, Cormode et al., “Time-Decaying Aggregates in Out-of-order Streams,” DIMACS Technical Report 2007-10, “Estimating the Confidence of Conditional Functional Dependencies,” SIGMOD '09, Jun. 29-Jul. 2, 2009, and Muthukrishnan presented methodologies where Q=Count-Distinct for different choices of P, in the context of mining multigraph data streams.

The problems with these methodologies are that they are too specific. First, they only solve a special case of the problem, when Q=Count-Distinct, and second, they do not work in a general data stream where one is allowed to insert and delete items.

### BRIEF SUMMARY

An exemplary aspect of an embodiment of the invention includes a method of approximating aggregated values from a data stream in a single pass over the data-stream where values within the data-stream are arranged in an arbitrary order, wherein the method includes, continuously receiving data sets from the data-stream using a computerized device, the data sets being arranged in the arbitrary order. The data sets are segmented according to previously established categories to create aggregates of the data sets using the computerized device. Variances are computed with respect to a mean of logarithmic values of the data sets using the computerized device, and averages of the variances are calculated to produce approximated aggregated values for the data stream using the computerized device. Finally, the approximated aggregate values are output from the computerized device.

With its unique and novel features, one or more embodiments of the invention provide a low-storage solution with an arbitrary ordering of data by maintaining random summaries, i.e., sketches, of the dataset, where the summaries arise from specific sampling techniques of the dataset.

The embodiments of the invention deal with complexity of estimating cascaded aggregates over a matrix presented as a sequence of updates and deletions in a data stream. A cascaded aggregate P∘Q is defined by evaluating aggregate Q repeatedly over each row of the matrix, and then evaluating aggregate P over the resulting vector of values. These have applications in the analysis of scientific data, stock market transactions, credit card fraud, and IP traffic.

The embodiments of the invention analyze the space complexity of estimating cascaded aggregates to within a small relative error for combinations of frequency moments (Fₖ) and norms (Lp).

1. For any 1≦k<∞ and 2≦p<∞, the embodiments of the invention obtain a 2-pass Õ(n^{2-2/p-2/(kp)})-space methodology for estimating Fₖ∘Fₚ. This is the embodiments of the invention main result, and is optimal up to polylogarithmic factors. In particular, the embodiments of the invention resolve an open question regarding the space complexity of estimating F₂∘F₂. The embodiments of the invention also obtain 1-pass space-optimal methodologies for estimating F∞∘Fₖ and Fₖ∘F∞.

2. For any k≧0, the embodiments of the invention obtain a 1-pass space-optimal methodology for estimating Fₖ∘L₂. The embodiments of the invention techniques also solve the “heavy hitters” problem for rows of the matrix weighted by L₂ norm.

### BRIEF DESCRIPTION OF THE SEVERAL VIEWS OF THE DRAWINGS

The foregoing and other exemplary purposes, aspects and advantages will be better understood from the following detailed description of an exemplary embodiment of the invention with reference to the drawings, in which:

FIG. 1 illustrates a data element in a matrix-like data stream;

FIG. 2 illustrates an arbitrary additive updated to a data element in a matrix-like data stream;

FIG. 3 illustrates a representation of a cascaded aggregate;

FIG. 4 illustrates a flowchart of a method of an embodiment of the invention;

FIG. 5 illustrates a flowchart of a method of an embodiment of the invention;

FIG. 6 illustrates a flowchart of a method of an embodiment of the invention; and

FIG. 7 illustrates a schematic diagram of a computer system that may implement the embodiments of the invention.

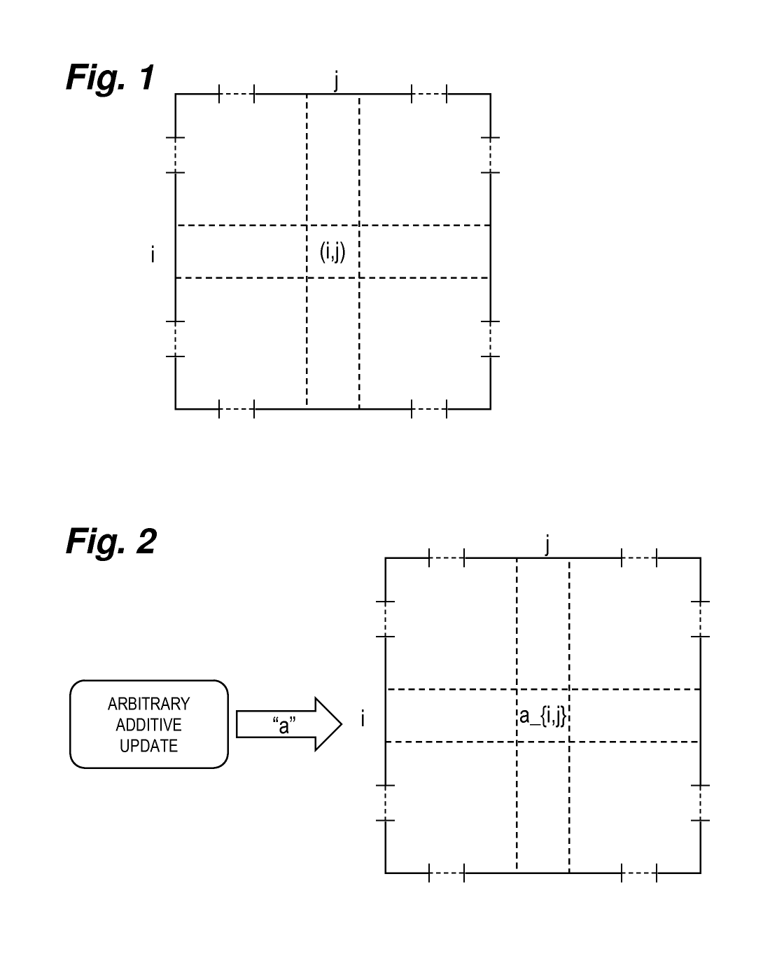

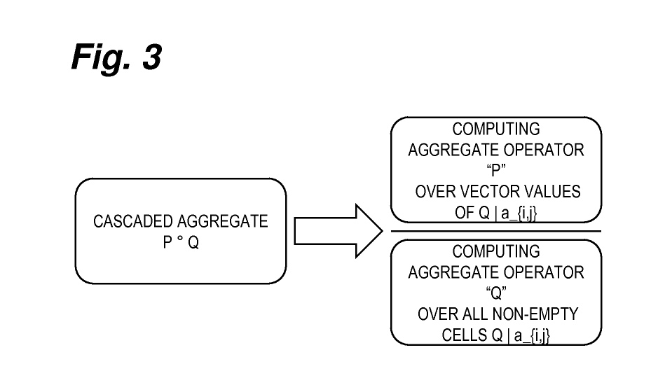

### DETAILED DESCRIPTION

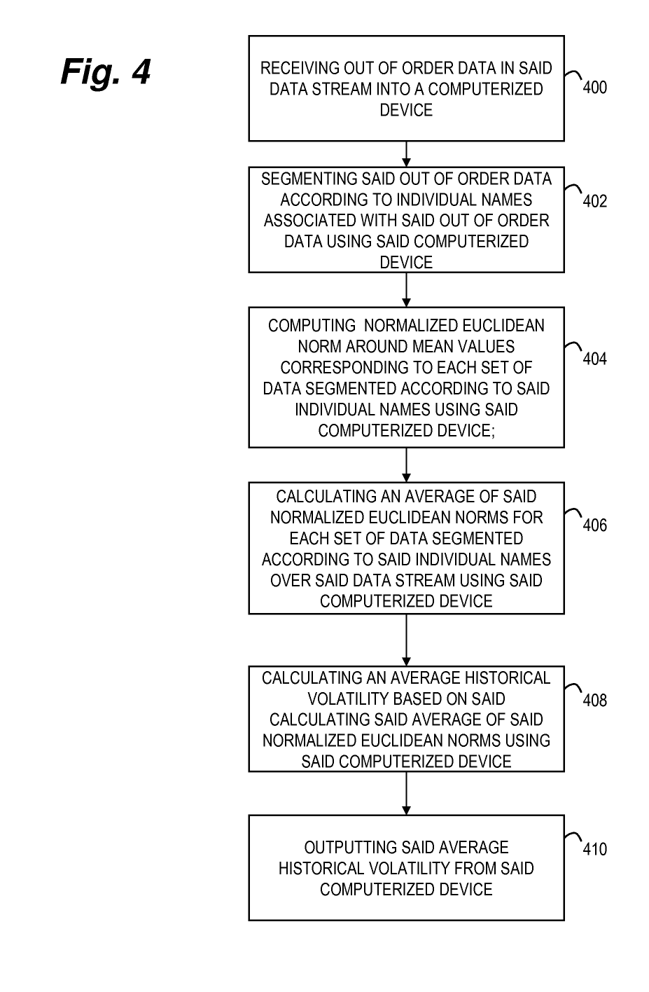

Referring now to the drawings, and more particularly to FIGS. 4-7, there are shown exemplary embodiments of the method and structures of the embodiments of the invention.

### Overview

The recent explosion in the processing of terabytesized data sets has led to significant scientific advances as well as competitive advantages for economic entities. With the widespread adoption of information technology in healthcare, and in the tracking of individual clicks over the internet, massive data sets have become increasingly important on a societal and personal level. The constraints imposed by processing this massive data have inspired highly successful new paradigms, such as the data stream model, in which a processor makes a quick “sketch” of its input data in a single pass and is able to extract important statistical properties of the data. This has yielded efficient methodologies for several classical problems in the area including frequency-based statistics, ranking based statistics, metric norms, and similarity measures (clustering the entries of the dataset into geometrically increasing intervals, and sampling a few items within each interval), and a complementary rich set of lower-bound techniques and results.

Classically, frequency moments and norms have played a major role in the foundations of processing massive data sets. Given a stream X in the turnstile model, let fₐ(X) denote the total weight of an item a induced by the increments and decrements, possibly weighted, to a. Define the k-th frequency moment

Fₖ(X) [symbol] Eₐ|fₐ(X)|^{k}

and the k-th norm

Lₖ(X) [symbol] (Fₖ(X))^{1/k}.

Special cases include distinct elements (F₀), Euclidean norms (L₂ and F₂), and the mode (F₁), all of which have been studied thoroughly. Estimating Fₖ for k>2 has applications in statistics to estimating the skewness and kurtosis of a random variable that provide a measure of asymmetry of a distribution. Let μₖ=E[(X−E[X])^{k}] be the k-th moment of X about the mean; the second moment of X about the mean, μ₂=σ² is the variance. Skewness is formally defined as the third moment of X about the mean, μ₃/σ³, and kurtosis is formally defined as the fourth moment of X about the means, μ₄/σ⁴−3. Skewness and kurtosis are used frequently to model and understand risk. Finally, they have also influenced the development of several related measures such as entropy and heavy-hitters.

Frequency moments and norms are a useful measure for single-shot aggregation. Most applications however deal with multi-dimensional data. In this scenario, the real insights are obtained by slicing the data multiple times, which involves applying several aggregate measures in a cascaded fashion. The following examples illustrate the power of such analysis:

Economics: In a stock market, the changes in various stock prices are recorded continuously using a quantity r_{log} known as “logarithmic return on investment”. To compute the average historical volatility of the stock market from the data, the data needs to be segmented according to the stock name, compute the variance of the r_{log} values recorded for that stock (i.e., normalized L₂ around the mean), and then compute the average of these values over all stocks (i.e., normalized F₁). Similarly, estimating the kurtosis risk in credit card fraud involves aggregating high-volume purchases made on individual credit card numbers. This is akin to computing F₁ on the transactions of individual credit cards followed by F₄ on the resulting values.

IP traffic: Cormode and Muthukrishnan considered various measures for IP traffic which could be used to identify whether large portions of the network may be under attack. A skewness measure that captures this property involves grouping the packets by source address, computing F₀ on the packets within each group based on the destination address (to count how many destination addresses are being probed) and then computing F₃ on the resulting vector of values for the source nodes.

Computational geometry: Consider indexed pointsets P={p₁, . . . , pₙ} and Q={q₁, . . . , qₙ} where each point belongs to R^{d} of high dimension. A useful distance measure between P and Q is the sum of squares of Lₚ distances between corresponding pairs of points, i.e.,

Σᵢ∥pᵢ−qᵢ∥ₚ².

If P contains k-distinct points (i.e., the matrix has k distinct rows), this could be the cost of the k-means problem with Lₚ-distances. If P is the projection of Q onto a k-dimensional subspace, this could be the cost of the best rank-k approximation with respect to squared Lₚ distances, a generalization of the approximate flat fitting problem to Lₚ distances.

Matrix approximation: Two measures that play a prominent role in matrix approximation are operator norm and maximum absolute row-sum norm. For a matrix A whose rows are denoted by A₁, A₂, . . . , Aₙ, they are defined as maxᵢ∥Aᵢ∥₂ and maxᵢ∥A₂∥₁, respectively.

Product Metrics: The Ulam distance between two non-repetitive sequences is the minimum number of character insertions, deletions, and substitutions needed to transform one sequence into the other. It is shown that for every “gap” factor, there is an embedding of the Ulam metric on sequences of length d into a product metric that preserves the gap. This embedding transforms the sequence into a d^{O(1)}×d^{O(1)} matrix; the distance between two matrices is obtained by computing the l_{∞} distance on corresponding rows followed by a l₂² computation. Interestingly, another embedding involving three levels of product metrics. The authors attempt to sketch F₂∘L_{∞}∘L₁, though they are not able to sketch this metric directly. Instead, they use additional properties of their embedding into this product metric to obtain a short sketch which is sufficient for their estimation of the Ulam metric.

The following problem captures the above scenarios involving two levels of aggregation:

Definition 1 (Cascaded Aggregates). Consider a stream X of length n consisting of updates to items in [m]×[m], where m=n^{O(1)}. Let M denote the matrix whose (i, j)-th entry is fᵢⱼ(X). Given two aggregate operators P and Q, the cascaded aggregate P∘Q is obtained by first applying Q to each row of M, and then applying P to the resulting vector of values. Abusing notation, the embodiments of the invention also apply P∘Q to X and denote (P∘Q)(X)=P(Q(X₁), Q(X₂), . . . , Q(Xₘ)), where Xᵢ for each i denotes the sub-stream of X corresponding to updates to item (i, j) for all j∈[m].

Cormode and Muthukrishnan focused mostly on the case P∘F₀ for different choices of P. For F₂∘F₀, they gave an methodology using Õ(√n) space (whereas the tilde notation hides poly(log n,1/∈) factors throughout this disclosure); for the heavy-hitters problem, they gave an methodology using space Õ(1) that returns a list of indices L such that (1) L includes all indices i such that F₀(Xᵢ)≧φm and (2) every index i∈L satisfies F₀(Xᵢ)≧(φ−∈)m.

The embodiments of the invention design computer-implemented methodologies for estimating several classes of cascaded frequency moments and norms. First, the embodiments of the invention give a near-complete characterization of the problem of computing cascaded frequency moments Fₖ∘Fₚ. The embodiments of the invention main result, and also technically the most involved, is the following:

for any k≧1 and p≧2, the embodiments of the invention obtain a 2-pass Õ(n^{2-2/p-2/(kp)})-space methodology for computing a (1±∈)-approximation to Fₖ∘Fₚ.

The embodiments of the invention prove that the complexity of the above-referenced computer-implemented methodology is optimal up to polylogarithmic factors. In particular, the embodiments of the invention show that the space complexity of estimating F₂∘F₂ is Θ(√n).

At the basic level, the computer-implemented methodology for Fₖ∘Fₚ cannot compute Fₚ(Xᵢ) individually for every i since that would take up too much space, which rules out using previous methodologies for frequency moments as a blackbox. On the other hand, the embodiments of the invention safely ignore those rows whose Fₚ(Xᵢ) values are relatively small. The crux of the embodiments of the invention problem is to focus in on those rows that have a significant contribution in terms of its Fₚ value without calculating them explicitly. This inherently forces us to delve deeper into the structure of methodologies for frequency moments. A promising direction is an methodology of which also yields an approximate frequency histogram. This can be used as a basis to non-uniformly sample rows from the input matrix according to its Fₚ value, and output an appropriate estimator. Although the estimator is straightforward, the analysis of this procedure is somewhat subtle due to the approximate nature of the histogram. However, a new wrinkle arises because the variance of the estimator is too large, and the samples obtained from the approximate histogram are not sufficient. Further, repeating the procedure will result in a huge blow-up in space.

The embodiments of the invention design a new computer-implemented methodology for obtaining a large number of samples according to an approximate histogram for Fₚ. The embodiments of the invention computer-implemented methodology uses a framework but adds new ingredients to limit the space used to generate the samples. In particular, the embodiments of the invention resort to another sub-sampling procedure to handle levels that have much more items than the expected number of samples needed from this level. The embodiments of the invention analysis then show that the samples from the approximate histogram estimator suffice to approximate Fₖ∘Fₚ. The computer-implemented methodology uses two (2) passes due to the separation of the sampling step from the step that evaluates the estimator.

Next, the embodiments of the invention study the problem of computing cascaded norms Lₖ∘L₂. For any k>0, the embodiments of the invention obtain a 1-pass space-optimal methodology for computing a (1±∈)-approximation to Fₖ∘L₂. The embodiments of the invention techniques also allow us to find all rows whose L₂ norm is at least a constant φ>0 fraction of F₁∘L₂ in Õ(1) space, i.e., to solve the “heavy hitters” problem for rows of the matrix weighted by L₂ norm.

Finally, for k≧1, the embodiments of the invention obtain 1-pass space-optimal methodologies for F_{∞}∘Fₖ and Fₖ∘F_{∞}.

The computer-implemented methodologies also have applications for entropy measures. This is very similar to an Fₖ estimation methodologies in a blackbox fashion setting k>1 close enough to 1 to estimate the entropy of a data stream.

As previously noted, Ganguly, Bansal, and Dube claimed an Õ(1)-space methodology for estimating Fₖ∘Fₚ for any k, p in [0, 2]. A simple reduction from multiparty set disjointness shows this claim is incorrect for any k, p for which k·p>2. Indeed, for such k and p a simple reduction from multiparty set disjointness shows that poly(n) space is required.

Reducing Randomness: For simplicity, the embodiments of the invention describe the computer-implemented methodologies using random oracles, i.e., they have access to an unlimited randomness including the use of continuous distributions. These assumptions can be eliminated by the use of pseudo-random generators, (PRGs), similar to the way Indyk used Nisan's generator. The extra ingredient, whose application to streaming methodologies seems to have escaped notice before, is the use of the PRG due to Nisan and Zuckerman and can be applied when the space used by the data stream methodology is n^{Ω(1)}. The advantage is that it does not incur the extra log factor in space incurred by Nisan's generator. Note that the same approach also results in a similar improvement in space in previous methodologies for frequency moments. This is summarized in the proposition below. It can be checked that the computer-implemented methodologies indeed satisfy the assumptions—the arguments are tedious but similar to those found in Indyk.

Proposition 2. Let P be a multi-pass, space s(n), data stream methodology on a stream X using (distributional) randomness R satisfying the following:

1. There exists a reordering of X (e.g., sort by item id) called X′ such that (i) all updates to each item a in X appear contiguously in X′, and (ii) P(X,R)=P(X′,R) with probability 1;

2. R can be broken into jointly independent chunks R_{a,k} over items a and passes k such that the only randomness used by P while processing updates to a in the k-th pass is R_{a,k};

3. for each a and k, there exists a polylog(n)-bit randomstring R_{a,k}=t(R_{a,k}) (e.g., via truncation) with the property that |P(X,R)=P(X,R)|≦n^{-Ω(1)} with probability 1.

Then there is an methodology P′ using random bits R′ with the following properties:
If s(n)=polylog(n) then P′ uses space s(n) log(n) and |R′|=O(s(n) log n);
If s(n)=poly (n) then P′ uses space s(n) and |R′|=O(s(n));
the distributions of P(X,R) and P′(X,R′) are statistically close to within any desirable constant.

The following is a convenient restatement of Hölder's inequality:

Proposition 3 (Hölder's inequality). Given a stream X of updates to at most M distinct items,

F₂(X)≦M^{1-2/p}·Fₚ(X)^{2/p}, if p≧2, and F₁(X)·M^{1-1/k}·Fₖ(X)^{1/k}, if k≧1

1. Cascaded Frequency Moments

Let Fₖₚ(X), for brevity, denote the cascaded frequency moment Fₖ∘Fₚ. In this section, the embodiments of the invention include a design of a 2-pass methodology for computing a 1±∈ estimate of Fₖₚ when k≧1, p≧2 using an optimal space Õ(m^{2-2/p-2/kp}). The lower bound follows via a simple reduction from multiparty set disjointness. Specifically, the inputs are t=(2m)^{1/p+1/kp} subsets such that on a NO instance, the sets are pairwise disjoint, and on a YES instance there exists (i, j) such that the intersection of every distinct pair of sets equals (i, j). The sets translate into an input X for Fₖₚ in a standard manner. For a NO instance, fᵢⱼ∈{0,1} for every i, j. Therefore Fₖₚ(X)≦Σᵢm^{k}=m^{k+1}. For a YES instance, fᵢⱼ=t for some i,j. Therefore, Fₖₚ(X), t^{kp}=(2m)^{k+1}. From the known communication complexity lower bounds for multiparty set disjointness for any constant number of passes, the space lower bound for Fₖₚ is Ω(m²/t²)=Ω(m^{2-/p-2/kp}).

1. Overview of the Methodology

The idealized version of the computer-implemented methodology is inspired by the methodology for computing Fₖ for k≧2. Consider the distribution on the rows of M, where the probability of choosing i is proportional to Fₚ(Xᵢ). If a sampling of a row I according to this distribution, then Fₚ(X₁)^{k-1} can be shown to be an unbiased estimator of Fₖₚ(X). By bounding the variance, it can be shown that there is a need to sample the rows m^{1-1/k} many times to obtain a good estimate of Fₖₚ.

The key obstacle is the sampling procedure. At the basic level, it is not beneficial to compute Fₚ(Xᵢ) for every i since that would take up too much space. For this, a subsampling technique is used by to give space-optimal methodologies for Fₚ. For this, the embodiments of the invention momentarily bypass the matrix structure and view items (i, j) as belonging to a domain D of size m². The goal will be to produce a sufficiently large number of weighted samples (i, j) according to its |fᵢⱼ(X)|^{p} value, and then use it to give an estimator for Fₖₚ(X). The subsampling technique however produces an approximate histogram that is only sensitive to Fₚ(X) (and ignores k): items are bucketed into groups, and groups that do not have a significant overall contribution to Fₚ(X) are implicitly discarded by the procedure. The embodiments of the invention analysis will show that the estimator is still a good approximation to Fₖₚ(X) in expectation. The variance causes a significant problem since one cannot run the sampling procedure several times to produce independent samples as that will cause severe blow-up in space. The embodiments of the invention overcome this by scavenging enough samples from each iteration of the subsampling procedure so that the space used is optimal.

2. Producing Samples Via an Approximate Histogram for Fₚ.

Fix a stream X whose items belong to an arbitrary set D of size n^{O(1)}. The embodiments of the invention partition items into levels according to their weights and identify levels having a significant contribution to Fₚ(X).

Notation: For η≧1, We say that x approximates y within η if y≦x≦η·y, and denote it by:

$$x {⇋}^{η} y . \\ Note that x {⇋}^{η} y and y {⇋}^{{η}^{′}} z implies that x {⇋}^{η {η}^{′}} z .$$

Definition 4. Let η=(1+∈)^{Θ(1)} and B≧1 denote two parameters. Define the level sets:

Sₜ(X)={a∈D:|fₐ(X)|∈[n^{t-1},n^{t}]} for 1≦t≦Cη log η, for some Cη. Call a level t contributing if

$$\vert {S}_{t} ( X ) \vert \cdot {η}^{pt} \geq \frac{{F}_{p} ( X )}{B ϑ} ,$$

where ∂=poly(log(n)/∈) will fixed by the analysis below. For a contributing level t, items in Sₜ(X) will also be called contributing items.

The main result of this section is a sampling methodology geared towards contributing items. The key new ingredient is stated in

Theorem 5. There is a one-pass methodology procedure called SAMPLE (X, Q; B, η) using space Õ((B^{2/p}+Q^{2/p})·|D|^{1-2/p}) that outputs the following (with high probability):

1. a set G that includes all contributing levels and values sₜ for t∈G such that

$${s}_{t} {⇋}^{{η}^{p + 2}} \vert {S}_{t} ( X ) \vert .$$

2. A quantity Φ such that

$$η Φ {⇋}^{{η}^{2 p + 3}} {F}_{p} ( X ) .$$

3. Q i.i.d samples such that for each individual sample, the probability qₐ that a is chosen satisfies

$${q}_{a} {⇋}^{{η}^{2 p + 2}} {\vert {f}_{a} ( X ) \vert}^{p} / Φ$$

### if a is in G.

Proof. In the proof, the embodiments of the invention will sometimes suppress the dependence on X for ease of presentation. Parts 1 and 2 essentially follow combining subsampling and the F₂ heavyhitters methodology to identify contributing levels. The key idea that drives the methodology is that for a contributing level, by Hölder's inequality,

$$\vert {S}_{t} \vert \cdot {η}^{2 t} \geq {( \vert {S}_{t} \vert \cdot {η}^{pt} )}^{2 / p} \geq \frac{{{F}_{p}}^{2 / p}}{{( B ϑ )}^{2 / p}} \geq \frac{{F}_{2}}{{( B ϑ )}^{2 / p} \cdot {\vert 𝒟 \vert}^{1 - 2 / p}} .$$

Using these ideas, an methodology of returns values sₜ for all t such that sₜ≦η|Sₜ|, and if t contributes, then sₜ≧|Sₜ|. The methodology also returns Fₚ with Fₚ≦Fₚ≦η^{p+1}Fₚ.

Define τ=Fₚ/(B∂η^{p+1}). The embodiments of the invention put t in G iff stη^{pt}≧τ.

Claim 6. If t is contributing, then t is in G.

Proof. By definition of contributing, |Sₜ|η^{pt}, Fₚ/(B∂), which is at least Fₚ/(B∂η^{p+1}). Moreover, since sₜ≧|Sₜ|, this implies that sₜη^{pt}≧Fₚ/(B∂η^{p+1}), which is τ, and thus τ is in G.

Claim 7. If t is in G, then sₜ≧|Sₜ|/η^{p+1}.

Proof. If t contributes, this follows by the definition of contribution. So suppose that t does not contribute, so that |Sₜ|η^{pt}≦Fₚ/(B∂). Since t is in G, sₜη^{pt}≧τ=Fₚ/(B∂η^{p+1}), but the latter quantity is ≧Fₚ/(B∂η^{p+1}) since Fp≧Fp. Hence, sₜ, Fₚ/(B∂η^{p+1})≧|Sₜ|/η^{p+1}, as desired.

The embodiments of the invention rescale the sₜ values for t∈G by multiplying them by η^{p+1}. Claims 6 and 7 now imply part 1. The space used equals Õ((B∂)^{2/p}·|D|^{1-2/p})=Õ(B^{2/p}·|D|^{1-2/p}).

For part 2, let Φ=Σ_{t∈G}s_{τ}(X)·η^{pt}. It is not hard to show that

$$η Φ {⇋}^{{η}^{2 p + 3}} {F}_{p} ( X )$$

by a bounding argument. This is because there are three sources of error:

(1) the frequencies in the Sₜ are discretized into powers of η;

(2)

$${s}_{t} {⇋}^{{η}^{p + 2}} \vert {S}_{t} ( X ) \vert ;$$

and

(3) Φ ignores Sₜ for t G. For (3), the embodiments of the invention need to assume that ∂ is sufficiently large.

For Part 3, fix t∈G and let

$${α}_{t} = \frac{{s}_{t} {η}^{pt}}{Φ} \cdot Q .$$

The quantity αₜ represents the expected number of samples that are needed from level t. Assume w log that Q≧η^{p+1}·B∂²(n); this will affect the space bound claimed in the theorem by only an Õ(1) factor. By definition of t in G, and by parts 1 and 2, the embodiments of the invention have

$$\begin{matrix}{α}_{t} = \frac{{s}_{t} {η}^{pt}}{Φ} \cdot Q \geq \frac{\vert {S}_{t} \vert {η}^{pt}}{{η}^{2 p + 4} {F}_{p}} \cdot Q \\ = \frac{\vert {S}_{t} \vert {η}^{pt}}{{F}_{p}} \cdot \frac{Q}{{η}^{2 p + 4}} \geq \frac{Q}{{η}^{2 p + 4} B ϑ} \geq ϑ ,\end{matrix}$$

The embodiments of the invention will now show how to obtain a uniform set of βₜ=c₁·min(αₜ, sₜ) samples without replacement from each contributing t, where c₁=Õ(1). Let j≧0 be such that sₜ/2^{j}·βₜ<sₜ/2^{j-1}. The key idea is sub-sampling: let h:D→{0,1} be a random function such that h(a)=1 with probability 1/2^{j} and the values h(a) for all a are jointly independent. In the stream, items a such that h(a)=0 are discarded. Let Yⱼ denote the stream of the surviving items. By Markov's inequality, the embodiments of the invention get that with high probability, (*)Fₚ(Yj)≦c₂Fₚ(X)/2^{j} and (**) the number of distinct items in Y^{j} is at most c₃|D|/2^{j}, where c₂=c3=Õ(1).

Now

$$\frac{{s}_{t}}{{2}^{j}} \leq {β}_{t} \leq {c}_{1} {α}_{t} = \frac{{c}_{1} {s}_{t} {η}^{pt}}{Φ} Q ,$$

which by rewriting and applying Part 2 yields

$${η}^{pt} \geq \frac{Φ}{{c}_{1} {2}^{j} Q} \geq \frac{{F}_{p}}{{c}_{1} η {2}^{j} Q} .$$

By Hölder's inequality, (*) and (**) above

$${η}^{2 t} = {( {η}^{pt} )}^{2 / p} \geq {( \frac{{F}_{p} ( XC )}{{c}_{1} η {2}^{j} Q} )}^{2 / p} \geq {( \frac{{F}_{p} ( {Y}_{j} )}{{c}_{1} {c}_{2} η Q} )}^{2 / p} \geq \frac{{F}_{2} ( {Y}_{j} )}{{( {c}_{1} {c}_{2} η Q )}^{2 / p} \cdot {( {c}_{3} \vert 𝒟 \vert / {2}^{j} )}^{1 - 2 / p}} \geq \frac{{F}_{2} ( {Y}_{j} )}{{CQ}^{2 / p} \cdot {\vert 𝒟 \vert}^{1 - 2 / p}} ,$$

for some C=Õ(1) since p≧2 implies that (2^{j})^{1-2/p}≧1. Thus by running an F₂-heavy hitters methodology on Y^{j}, the embodiments of the invention will find every sub-sampled item of Sₜ. With high probability, the embodiments of the invention can show that the number of items will be Ω(βt) which by rescaling βt by an Õ(1) factor, is at least c₁·min(αₜ, sₜ), the number of samples needed.

To finish the proof, for each iteration q=1, . . . , Q, we pick a level t∈G with probability

$$\frac{{α}_{t}}{Q} = \frac{{s}_{t} {η}^{p t}}{Φ} .$$

By Markov's inequality and union bound, no level t is picked more than c₁αₜ times with high probability. By the argument above, the embodiments of the invention indeed have this many samples for each t but these are samples obtained without replacement. Then, by Lemma 8 shown below, the embodiments of the invention get a uniformly chosen sample in Sₜ, independent of the other iterations. The probability that a contributing item a belonging to level t is chosen is given by:

$$\frac{{s}_{t} {η}^{p t}}{Φ} \frac{1}{\vert {S}_{t} \vert} {⇋}^{{η}^{p + 2}} \frac{{η}^{p t}}{Φ} {⇋}^{{η}^{p}} \frac{{{f}_{a} ( X )}^{p}}{Φ} .$$

Lemma 8. If the embodiments of the invention have a sample of size t, chosen uniformly without replacement from a domain of known size, then the embodiments of the invention can obtain a sample of size t chosen uniformly with replacement.

3. Computing Fₖₚ when k≧1, p≧2.

Recalling the setup, the embodiments of the invention are given a stream X of items of length n, each belonging to [m]×[m]. Let Xᵢ denote the sub-stream of X corresponding to updates to item (i, j) for all j∈[m]. The embodiments of the invention show how to compute

F̅ₖₚ(X) [symbol] Σᵢ(Σⱼ|fᵢⱼ(X)|^{p})^{k}=Σᵢ|Fₚ(Xᵢ)|^{k}.

Consider the pseudo-code shown in Methodology 1, which runs in 2 passes.

Methodology 1: Compute Fₖₚ(X).

1. Call SAMPLE (X,Q;B,η) with Q=B=m^{1-1/k}, to obtain G, sₜ for each t∈G, and Q samples.

2. Let Φ=Σ_{t∈G}sₜ·η^{pt}

3. For each sample (i, j), estimate Fₚ(Xᵢ)^{k-1} by invoking Sample(X,Q;B,η) with Q=B=1. Let Ψ denote the average of the estimates for all samples.

4. Output Φ·Ψ.

The embodiments of the invention will prove the correctness of Methodology 1 via the following claims. First, the embodiments of the invention show that for estimating Fₖₚ(X), the embodiments of the invention can eliminate the t's not in G.

Lemma 9. For any

t∉G,|Sₜ(X)|·η^{pt}≦ F̅ₖₚ(X)^{1/k}/∂.

Proof. If

t∉G,

then by Theorem 5, t is not contributing. Hence,

$$\vert {S}_{t} ( X ) \vert \cdot {η}^{pt} \leq \frac{{F}_{p} ( x )}{B ϑ}$$

By Hölder's inequality, for k≧1,

$${F}_{p} ( X ) = {\sum }_{i} \vert {F}_{p} ( {X}_{i} ) \vert \leq {( {\sum }_{i} \vert {F}_{p} ( {X}_{i} ) \vert )}^{1 / k} \cdot {m}^{1 - 1 / k} = {{\overline{F}}_{kp} ( X )}^{1 / k} \cdot {m}^{1 - 1 / k}$$

Setting B=m^{1-1/k} the embodiments of the invention obtain

$$\vert {S}_{t} ( X ) \vert \cdot {η}^{pt} \leq \frac{{{\overline{F}}_{kp} ( X )}^{1 / k}}{ϑ}$$

The next lemma shows that the t's in G provide a good estimate of Fₖₚ(X).

Lemma 10. Define the stream Y by including only the items that belong to levels tεG in the stream X.

$$For any ɛ > 0 , {\overline{F}}_{kp} ( Y ) {⇋}^{1 + ɛ} {\overline{F}}_{kp} ( X ) .$$

Proof. Let N denote the set of items that belong to levels t∈G. Since Fₖₚ(X) is a monotonic function in terms of the various |fᵢⱼ(X)|'s, and deleting items in N causes their weights to drop to 0, it follows that Fₖₚ(Y)≦Fₖₚ(X). The embodiments of the invention will next show that Fₖₚ(X)≦(1+∈)·Fₖₚ(Y). First, there occurs:

$${\overline{F}}_{kp} ( X ) = {\sum }_{i} {{F}_{p} ( {X}_{i} )}^{k} = {\sum }_{i} {( {F}_{p} ( {Y}_{i} ) + {\sum }_{j : ( i , j ) ∈ N} {\vert {f}_{ij} ( X ) \vert}^{p} )}^{k} \qquad ( 1 )$$

Assume w log that

Fₚ(Y₁)≧Fₚ(Y₂)≧ . . . ≧Fₚ(Yₘ).

Since the function

f(x₁,x₂, . . . , xₘ)=Σᵢ₌₁^{m}xᵢ^{k}

### is Schur-convex,

$${\overline{F}}_{kp} ( X ) \leq {( {F}_{p} ( {Y}_{1} ) + {\sum }_{( i , j ) ∈ N} {\vert {f}_{ij} ( X ) \vert}^{p} )}^{k} + {\sum }_{i > 1} {{F}_{p} ( {Y}_{i} )}^{k} \qquad ( 2 )$$

Now,

Σ_{i>1}Fₚ(Yᵢ)^{k}= F̅ₖₚ(Y)−Fₚ(Y₁)^{k}, and

Σ_{(i,j)∈N}|fᵢⱼ(X)|^{p}≦Σ_{t∉G}|Sₜ(X)|·η^{pt}.

Substituting these bounds in (2),

$${\overline{F}}_{kp} ( X ) \leq {\overline{F}}_{kp} ( Y ) - {{F}_{p} ( {Y}_{1} )}^{k} + {( {F}_{p} ( {Y}_{1} ) + {\sum }_{t ∉ G} \vert {S}_{t} ( X ) \vert \cdot {η}^{pt} )}^{k} \qquad ( 3 )$$

Let

U [symbol] Fₚ(Y₁) and V [symbol] Σ_{r∉G}|Sₜ(X)|·η^{pt}.

Consider 2 cases. If U≧kV/∈, then

(U+V)^{k}≦U^{k}(1+∈/k)^{k}≦U^{k}(1+∈)=Fₚ(Y₁)^{k}(1+∈)≦Fₚ(Y₁)^{k}+∈ F̅ₖₚ(Y)

Substituting this bound in (3) proves the lemma for this case.

Otherwise, i.e., U<kV/∈. By Lemma 9,

$${V}^{k} = {( {\sum }_{t ∉ G} \vert {S}_{t} ( X ) \vert \cdot {η}^{pt} )}^{k} \leq O ( {log}^{k} n ) \frac{{\overline{F}}_{kp} ( X )}{ϑ} .$$

Since U<kV/∈, we have

$${( U + V )}^{k} \leq {{V}^{k} ( 1 + k / ɛ )}^{k} \leq {\overline{F}}_{kp} ( X ) \frac{O ( {log}^{k} n ) {( 1 + k / ɛ )}^{k}}{ϑ} .$$

Choose the denominator ∂ to be small enough so that (U+V)^{k}≦Fₖₚ(X). Applying this bound in (3),

F̅ₖₚ(X)≦ F̅ₖₚ(Y)+∈ F̅ₖₚ(X)−Fₚ(Y₁)≦ F̅ₖₚ(Y)(1+∈),

which completes the proof of the lemma.

Next, analyze Step 3 of the methodology:

Lemma 11. The probability of choosing a certain i in Step 3 approximates Fₚ(Yᵢ)Φ within η^{2p+2}.

Proof. By Theorem 5, the probability that (i, j) is chosen approximates |fᵢⱼ(X)|^{p}/Φ within η^{2p+2} provided (i, j) is in a level which is in G and equals 0 otherwise. Summing over all such (i, j) for various j's,

$${\sum }_{j : ( i , j ) is in G} {\vert {f}_{ij} ( X ) \vert}^{p} / Φ = {F}_{p} ( {Y}_{i} ) / Φ$$

Theorem 12. The output in Step 4 is a good estimate of Fₖₚ(X).

Proof. By Lemma 11,

$$𝔼 [ Φ Ψ ] {⇋}^{{η}^{2 p + 2}} {\sum }_{i} \frac{{F}_{p} ( {Y}_{i} )}{Φ} Φ Ψ = {\sum }_{i} {F}_{p} ( {Y}_{i} ) Ψ \qquad ( 4 )$$

For each i within the sum, applying Theorem 5, part 2, it is known that Ψ approximates Fₚ(Xᵢ)^{k-1} within η^{(2p+2)(k-1)}. Substituting in (4),

$$𝔼 [ Φ Ψ ] {⇋}^{{η}^{( 2 p + 2 ) k}} {\sum }_{i} {F}_{p} ( {Y}_{i} ) {{F}_{p} ( {X}_{i} )}^{k - 1} {=}^{Δ} A$$

Observe that since Fₚ(Yᵢ)≦Fₚ(Xᵢ), one has Fₖₚ(Y)≦A≦Fₖₚ(X). Applying Lemma 10, and choosing η to be sufficiently close to 1 shows that the expected value of the estimator is a good approximation of Fₖₚ(X). Turning to the variance,

$$𝔼 [ {( Φ Ψ )}^{2} ] \leq {η}^{2 p + 2} {\sum }_{i} \frac{{F}_{p} ( {Y}_{i} )}{Φ} {Φ}^{2} {Ψ}^{2} = {η}^{2 p + 2} {\sum }_{i} {F}_{p} ( {Y}_{i} ) {ΦΨ}^{2} ,$$

Applying the same inequalities as above, Fₚ(Yᵢ)≦Fₚ(Xᵢ), and Φ≦η^{2p+2}Fₚ(X), as well as Ψ≦η^{(2p+2)(2k-2)}Fₚ(Xᵢ)^{2k-2}. Therefore,

$$𝔼 [ {( Φ Ψ )}^{2} ] \leq {η}^{( 2 k - 1 ) ( 2 p + 2 ) + 2 p + 2} {\sum }_{i} {F}_{p} ( {X}_{i} ) {F}_{p} ( X ) {{F}_{p} ( Xi )}^{2 k - 2} = {η}^{( 2 k - 1 ) ( 2 + 2 ) + 2 p + 2} {F}_{p} ( X ) {\sum }_{i} {{F}_{p} ( {X}_{i} )}^{2 k - 1}$$

Since,

Fₚ(X)=ΣᵢFₚ(Xᵢ)≦m^{1-1/k} F̅_{k,p}(X)^{t/k}, and ΣᵢFₚ(Xᵢ)^{2k-1}≦(ΣᵢFₚ(Xᵢ)^{k})^{2k-1/k}= F̅ₖₚ(X)^{2-1/k},

thus is obtained

E[(ΦΨ)²]≦m^{1-t/k} F̅ₖₚ(X)²,

up to an Õ(1) factor, so there are just enough samples to obtain a good estimate of F_{k,p}(X).

### Exemplary Aspects

Referring again to the drawings, FIG. 4 illustrates an exemplary embodiment of the invention of a computer-implemented method that approximates an average historical volatility in a data stream in a single pass over a dataset, wherein the method begins by receiving out-of-order data in the data stream into a computerized device 400. The embodiment of the invention segments the out-of-order data according to individual names associated with the out-of-order data using the computerized device 402. A normalized Euclidean norm is computed around mean values corresponding to each set of data segmented according to the individual names using the computerized device 404.

An average of the normalized Euclidean norms is calculated 406 for each set of data segmented according to the individual names over the data stream using the computerized device, and an average historical volatility is calculated based on the calculating the average of the normalized Euclidean norms using the computerized device 408. Finally, the average historical volatility is output from the computerized device 410.

Calculating the average historical volatility may be performed while continuously receiving the out-of-order data over an indefinite period of time. The out-of-order data may be received using a quantity r log, also known as a “logarithmic return on investment.” The individual names associated with the data may include stock names, for example. Computing the normalized Euclidean values around the mean values may further comprise computing a variance of the r log values.

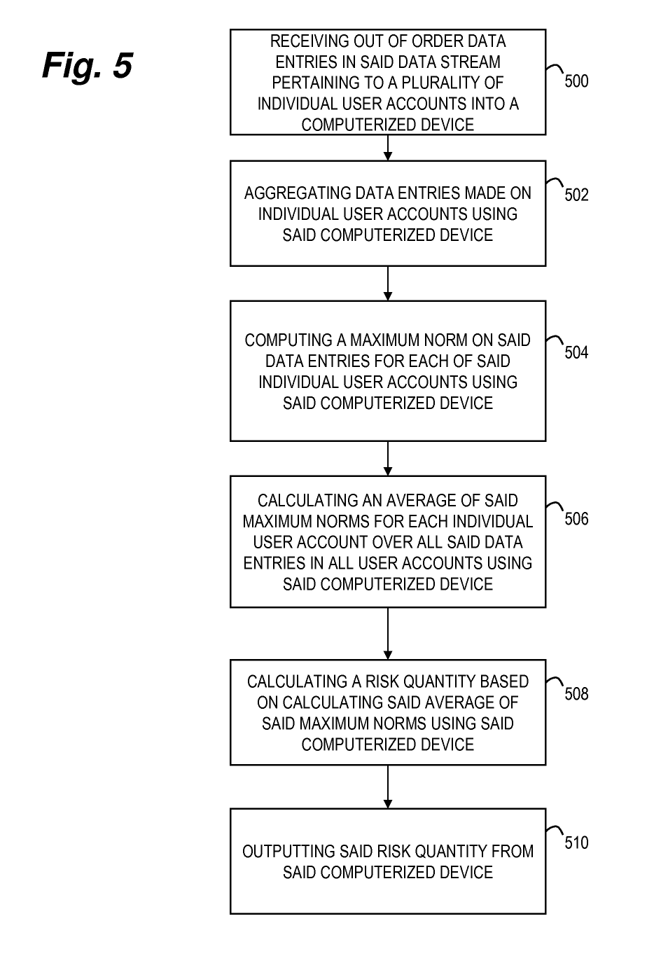

FIG. 5 illustrates an exemplary embodiment of the invention of a computer-implemented method to calculate a risk quantity in a data stream in a single pass over a dataset, wherein the method includes receiving out-of-order data entries in the data stream pertaining to a plurality of individual user accounts into a computerized device 500. Data entries are aggregated made on individual user accounts using the computerized device 502. A maximum norm is computed on the data entries for each of the individual user accounts using the computerized device 504. An average of the maximum norms is computed for each individual user account over all the data entries in all user accounts using the computerized device 506. A risk quantity is calculated based on calculating the average of the maximum norms using the computerized device 508, and finally, the risk quantity is output from the computerized device 510.

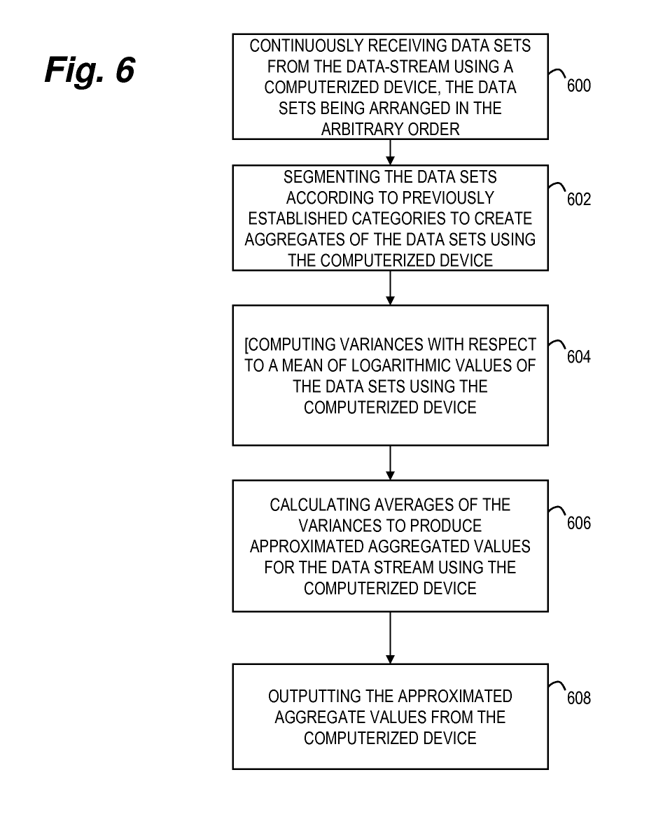

FIG. 6 illustrates an exemplary embodiment of the invention of a computer-implemented method of approximating aggregated values from a data stream in a single pass over the data-stream where values within the data-stream are arranged in an arbitrary order, wherein the method includes continuously receiving data sets from the data-stream using a computerized device, wherein the data sets are arranged in the arbitrary order 600. The data sets are segmented according to previously established categories to create aggregates of the data sets using the computerized device 602. Variances are computed with respect to a mean of logarithmic values of the data sets using the computerized device 604. Averages of the variances are calculated to produce approximated aggregated values for the data stream using the computerized device 606, and finally, the approximated aggregate values are output from the computerized device 608.

With its unique and novel features, one or more embodiments of the invention provide a low-storage solution with an arbitrary ordering of data by maintaining random summaries, i.e., sketches, of the dataset, where the summaries arise from specific sampling techniques of the dataset, specifically, sampling the dataset at intervals at specific intervals according to a particular power, e.g., at a power of two (2): where intervals would comprise 1-2, 3-4, 5-8, 9-16, 17-32, 33-64, etc. Each interval is incremented each occurrence of that received data falls within a specified interval. The embodiment of the invention then will sample a single data point, (e.g., stock name, time, value), within a single interval. A second pass over the data then computes the variance of the sampled single data point on all the segmented data having the common value which the data was segmented, e.g., a stock name.

A method is given for efficiently approximating cascaded aggregates in a data stream in a single pass over a dataset, with entries presented to the methodology in an arbitrary order.

For example, in a stock market, the changes in various stock prices are recorded continuously using a quantity r log known as the logarithmic return on investment. The average historical volatility is computed from data by segmenting the data according to stock name, computing the variance of the r log values recorded for that stock (i.e., normalized Euclidean norm around the mean), and computing the average of these values over all stocks (i.e., normalized L₁-norm).

Similarly, estimating the kurtosis risk in credit card fraud involves aggregating high-volume/value purchases made on individual credit card numbers. This is akin to computing the maximum norm on the transactions of individual credit cards followed by the L₄-norm on the resulting values.

While previous data streaming methods address norm computation of datasets, the method here is the first to address the problem of cascaded norm computations, namely, the computation of the norm of a column of norms, one for each row in the dataset. Trivial solutions to this problem are obtained by either storing the entire database and performing an offline methodology, or assuming the data is presented in a row by row order. The first solution is impractical for massive datasets stored externally, which cannot even fit in RAM. The second solution requires an unrealistic assumption, i.e., that data is arriving on a network in a predictable order. The method presented here provides a low-storage solution with an arbitrary ordering of data by maintaining random summaries (e.g., sketches) of the dataset. The summaries arise from novel sampling techniques of the dataset.

As will be appreciated by one skilled in the art, an embodiment of the invention may be embodied as a system, method or computer program product. Accordingly, an embodiment of the invention may take the form of an entirely hardware embodiment, an entirely software embodiment (including firmware, resident software, micro-code, etc.) or an embodiment combining software and hardware aspects that may all generally be referred to herein as a ‘circuit,’ ‘module’ or ‘system.’ Furthermore, an embodiment of the invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of an embodiment of the invention may be written in any combination of one or more programming languages, including an object oriented programming language such as Java, Smalltalk, C++ or the like and conventional procedural programming languages, such as the ‘C’ programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

An embodiment of the invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

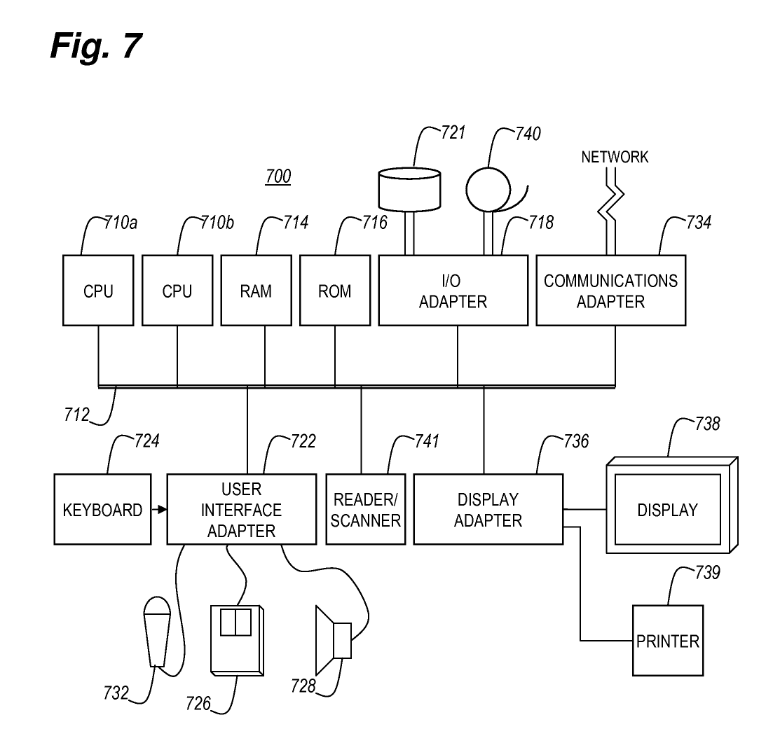

Referring now to FIG. 7, system 700 illustrates a typical hardware configuration which may be used for implementing the inventive system and method for approximating average historical volatility in a data stream in a single pass over a dataset. The configuration has preferably at least one processor or central processing unit (CPU) 710a, 710b. The CPUs 710a, 710b are interconnected via a system bus 712 to a random access memory (RAM) 714, read-only memory (ROM) 716, input/output (I/O) adapter 718 (for connecting peripheral devices such as disk units 721 and tape drives 740 to the bus 712), user interface adapter 722 (for connecting a keyboard 724, mouse 726, speaker 728, microphone 732, and/or other user interface device to the bus 712), a communication adapter 734 for connecting an information handling system to a data processing network, the Internet, and Intranet, a personal area network (PAN), etc., and a display adapter 736 for connecting the bus 712 to a display device 738 and/or printer 739. Further, an automated reader/scanner 741 may be included. Such readers/scanners are commercially available from many sources.

In addition to the system described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, including signal-bearing media tangibly embodying a program of machine-readable instructions executable by a digital data processor to perform the above method.

Such a method may be implemented, for example, by operating the CPU 710 to execute a sequence of machine-readable instructions. These instructions may reside in various types of signal bearing media.

Thus, this aspect of the present invention is directed to a programmed product, comprising signal-bearing media tangibly embodying a program of machine-readable instructions executable by a digital data processor incorporating the CPU 710 and hardware above, to perform the method of the invention.

The flowchart and block diagrams in the figures illustrate the architecture, functionality, and operation of possible implementations of systems, methods and computer program products according to various embodiments of the invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of any embodiments of the invention. As used herein, the singular forms ‘a’, ‘an’ and ‘the’ are intended to include the plural forms as well, unless the context clearly indicates otherwise. It will be further understood that the terms ‘comprises’ and/or ‘comprising,’ when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments of the invention has been presented for purposes of illustration and description, but is not intended to be exhaustive or limited to the embodiments of the invention in the form disclosed. Many modifications and variations will be apparent to those of ordinary skill in the art without departing from the scope and spirit of the embodiments of the invention. The embodiment was chosen and described in order to best explain the principles of the embodiments of the invention and the practical application, and to enable others of ordinary skill in the art to understand the embodiments of the invention for various embodiments with various modifications as are suited to the particular use contemplated.

What is claimed is:

1. A computer-implemented method of approximating average historical volatility in a data stream in a single pass over a dataset, said method comprising:
receiving out-of-order data in said data stream into a computerized device;
segmenting said out-of-order data according to individual names associated with said out-of-order data using said computerized device;
computing normalized Euclidean norm around mean values corresponding to each set of data segmented according to said individual names using said computerized device;
calculating an average of said normalized Euclidean norms for each set of data segmented according to said individual names over said data stream using said computerized device;
calculating an average historical volatility based on said calculating said average of said normalized Euclidean norms using said computerized device; and
outputting said average historical volatility from said computerized device.

2. The method according to claim 1, wherein said calculating said average historical volatility is performed while continuously receiving said out-of-order data over an indefinite period of time.

3. The method according to claim 1, wherein said out-of-order data is received using a quantity r log.

4. The method according to claim 3, wherein said data comprises a logarithmic return on investment.

5. The method according to claim 1, wherein said individual names associated with said data includes stock names.

6. The method according to claim 3, wherein said computing said normalized Euclidean values around said mean values further comprises computing a variance of said r log values.

7. A computer-implemented method of calculating a risk quantity in a data stream in a single pass over a dataset, said method comprising:
receiving out-of-order data entries in said data stream pertaining to a plurality of individual user accounts into a computerized device;
aggregating data entries made on individual user accounts using said computerized device;
computing a maximum norm on said data entries for each of said individual user accounts using said computerized device;
calculating an average of said maximum norms for each individual user account over all said data entries in all user accounts using said computerized device;
calculating a risk quantity based on calculating said average of said maximum norms using said computerized device; and
outputting said risk quantity from said computerized device.

8. The method according to claim 7, wherein said risk quantity is performed while continuously receiving said out-of-order data entries over an indefinite period of time.

9. The method according to claim 7, wherein said individual user accounts comprise individual user credit card accounts.

10. The method according to claim 7, wherein said data entries comprise one of a volume quantity and a value quantity.

11. The method according to claim 7, wherein said risk quantity further comprises a kurtosis risk value, wherein kurtosis is the fourth moment about a mean value.

12. The method according to claim 11, wherein said kurtosis risk value further comprises a credit card fraud risk value.

13. A computer-implemented method of approximating aggregated values from a data stream in a single pass over said data-stream where values within said data-stream are arranged in an arbitrary order, said method comprising:
continuously receiving data sets from said data-stream using a computerized device, said data sets being arranged in said arbitrary order;
segmenting said data sets according to previously established categories to create aggregates of said data sets using said computerized device;
computing variances with respect to a mean of logarithmic values of said data sets using said computerized device;
calculating averages of said variances to produce approximated aggregated values for said data stream using said computerized device; and
outputting said approximated aggregate values from said computerized device.

14. The method according to claim 13, wherein said calculating said value based on said previously established categories is performed while continuously receiving said out-of-order data over an indefinite period of time.

15. The method according to claim 13, wherein said continuously received data sets are time-series related data.

16. The method according to claim 13, wherein said previously established categories includes stock names.

17. The method according to claim 13, wherein said previously established categories includes individual user credit card accounts.

18. The method according to claim 13, wherein said previously established categories comprise one of a high volume quantity and a high value quantity.

19. The method according to claim 13, wherein said previously established categories comprise individual names associated with said data.

20. A computer program product for approximating cascaded aggregates in a data stream in a single pass over a dataset, the computer program product comprising:
a computer readable storage medium having computer readable program code embodied therewith, the computer readable program code comprising: computer readable program code configured to:
continuously receive data sets from said data-stream, said data sets being arranged in said arbitrary order;
segment said data sets according to previously established categories to create aggregates of said data sets;
compute variances with respect to a mean of logarithmic values of said data sets;
calculating averages of said variances to produce approximated aggregated values for said data stream; and
output said approximated aggregate values.
